(19) United States
(12) Patent Application Publication
(10) Pub. No.: US 2020/0216979 A1
(43) Pub. Date: Jul. 9, 2020

(54) MULTI-DIE MELT BLOWING SYSTEM FOR FORMING CO-MINGLED STRUCTURES AND METHOD THEREOF

(71) Applicant: Groz-Beckert KG, Albstadt (DE)

(72) Inventors: Behnam Pourdeyhimi, Cary, NC (US); Eunkyoung Shim, Raleigh, NC (US)

(21) Appl. No.: 16/789,295

(22) Filed: Feb. 12, 2020

Related U.S. Application Data
(62) Division of application No. 15/319,622, filed on Dec. 16, 2016, now abandoned.
(60) Provisional application No. 62/012,646, filed on Jun. 16, 2014.

(51) Int. Cl. D01D 4/02; D04H 3/153; D04H 1/732; D04H 1/724; D04H 1/435; D04H 1/4291; B01D 39/08; D04H 1/56; D04H 1/4382; D01D 5/098; D01D 5/08

(52) U.S. Cl. CPC D01D 4/025; D04H 3/153; D04H 1/732; D04H 1/724; D04H 1/435; D04H 1/4291; B01D 2239/0618; D04H 1/56; D04H 1/4382; D01D 5/0985; D01D 5/082; D10B 2505/04; B01D 2239/0622; B01D 39/083

(57) ABSTRACT

A melt blowing system for the manufacturing of pleatable/moldable nonwoven fabrics includes a collector positioned to receive a plurality of fibers, a first die in fluid communication with a first liquid polymer supply having a melt flow index of about 500 or lower, and a second die in fluid communication with a second liquid polymer supply having a melt flow index of about 500 or higher. The first die has a concentric air design, includes a plurality of spinneret nozzles facing the collector surface, and is configured to draw a first plurality of fibers. The second die includes a plurality of spinneret nozzles having smaller capillary diameter than those of the first die and is positioned to draw a second plurality of fibers such that the first and second pluralities of fibers form a co-mingled nonwoven web with varying fiber diameters on the collector surface.

### CROSS REFERENCE TO RELATED APPLICATIONS

This patent application is a divisional of U.S. patent application Ser. No. 15/319,622, filed Dec. 16, 2016, which is the national phase of PCT/US2015/036007 filed Jun. 16, 2015, which claims the benefit of U.S. patent application Ser. No. 62/012,646, filed Jun. 16, 2014. U.S. patent application Ser. No. 15/319,622 is hereby incorporated by reference in its entirety.

### FIELD OF THE INVENTION

The present invention relates to a melt blowing system comprising two or more dies that can be configured to form co-mingled nonwoven structures, as well as comingled nonwoven structures formed using such a system that will incorporate particles and other additives into the web.

### BACKGROUND OF THE INVENTION

Synthetic fibers are widely used in a number of diverse applications to provide stronger, thinner, and lighter weight products. Furthermore, synthetic thermoplastic fibers are typically thermobondable and thus are particularly attractive for the manufacture of nonwoven fabrics, either alone or in combination with other non-thermoplastic fibers (such as cotton, wool, and wood pulp, for example). Nonwoven fibrous networks, in turn, are increasingly used as a substitute for conventional woven textiles due in part to their low cost of production. The nonwoven fibers are initially presented as unbound fibers or filaments, which may be natural or man-made. A key step in the manufacturing of nonwovens involves binding the various fibers or filaments together. The manner in which the fibers or filaments are bound can vary, and include both mechanical and chemical techniques that are selected in part based on the desired characteristics of the final product.

Melt blowing technology is a melt-spun process that can be used to produce microfibers by injecting a molten polymer stream into high velocity gas jets. Conventional meltblown structures are made from low molecular weight, low viscosity polymers to form highly drawn micro and nanofiber webs. For example, a large number of conventional meltblown structures are made from polypropylene (PP) since they are readily available in low viscosities which are required to form fine fibers. Although it is possible to form meltblown structures from polybutylene terephthalate (PBT), polyethylene terephthalate (PET), Nylons and other fiber grade polymers, the higher viscosities of these polymers leads to larger fibers, which can be undesirable in meltblown fabrics as meltblown structures are commonly used in filtration applications ranging from HVAC filters to facemasks and respirators to liquid filtration. Consequently, conventional meltblown fibers are fine and the fabrics formed therefrom are weak and have limited extensibility. Therefore, conventional meltblown structures can be difficult to pleat and/or mold.

Additives have been used to strengthen or otherwise alter characteristics of meltblown fibers. Similarly, different bonding techniques or other processes can be applied to meltblown structures to strengthen the meltblown structure and afford higher extensibility such that the meltblown structure can be more readily molded, pleated or shaped. See, e.g., European Pat. Nos. 0 848 636 to Legare; 0 498 002 to Aigner et al.; 1 050 331 to Strauss; 1 208 959 to Dickerson et al.; 1 339 477 to Doherty; 2 043 756 to Wu; 2 049 226 to Brandner et al.; 2 162 028 to Angadjivand et al.; and 2 227 308 to Freeman et al.; and U.S. Pat. Nos. 5,306,321 to Osendorf; 5,427,597 to Osendorf; 6,585,838 to Mullins et al.; 7,326,272 to Hornfeck et al.; 8,343,251 to Ptak et al.; and 8,361,180 to Lim et al.; each of which is herein incorporated by reference. See also the attempts to improve the pleatability of meltblown fabrics described in U.S. Pat. Nos. 5,306,321; 5,427,597; 7,326,272; 8,361,180; 8,343,251; and European Pat. Nos. 1339477 A1; 2043756 A1; 2049226 B1; 2162028 B1; 2167714 B1; and 2227308 A2; each of which is incorporated herein by reference.

There have been numerous attempts to improve the pleatability of meltblown fabrics. For example, it is customary to laminate a meltblown structure to a heavier spunbound fabric or a scrim in order to facilitate pleating. In such a case, the meltblown fabric is attached to the spunbound web or to the scrim and is carried by this heavier layer that serves to hold the desired shape. For example, European patent EP 1050331 B2, which is incorporated by reference herein, uses a two or multi-layered structure of which one layer is a meltblown medium. See also the structures exemplified in EP 0848636 B1, and EP 0498002 A1, each of which is incorporated herein by reference. Ultrasonic bonding has also been used, for example, to impart additional stiffness to meltblown media, thereby enabling pleating. See, e.g., U.S. Pat. No. 6,585,838 and European Pat. No. 1208959 B1, each of which is incorporated herein by reference.

It is known that multiple meltblown fiber streams can be co-mingled such that a hybrid structure is formed. See, e.g., U.S. Pat. Nos. 3,971,373; 7,754,041; 7,682,554; 7,807,591; and 8,372,175; each of which is incorporated herein by reference. In addition, a third material (e.g., fibers and/or particles) can be deposited into the co-mingled web and/or into a single meltblown fiber stream. See, e.g., EP 0156160 A2 and EP 0080382 A2, each of which is incorporated herein by reference. U.S. Pat. No. 8,834,762 is directed to a pleatable nonwoven structure comprising thicker fibers and thinner fibers constructed of the same material, but requires use of high-viscosity polymer melts of well below 500 MFI and particularly emphasizes the need for high-viscosity polymer melts to achieve fibers with very small diameter. It remains necessary to improve the pleatability and/or moldability of co-mingled hybrid structures as well as the manner in which particles or a third component can be introduced into the web.

From the foregoing, it is clear that meltblown structures alone typically are not pleatable and there is a need for a self-supporting single layer meltblown structure that can be easily pleated and can hold the shape of the pleat, and which can be made using manufacturing processes that are conducive to efficient production of the meltblown structures. Such a structure will offer moldability/pleatability leading to lower cost since it does not require additional layers, bonding agents or fibers to achieve pleatability. Furthermore, the final structure can be relatively thinner, allowing for a higher number of pleats per unit area, thereby leading to improved pressure drop due to increased filter surface area.

There remains a need for a new and improved system and method to form co-mingled structures that exhibit increased strength and pleatability/moldability characteristics as well as the ability to “trap” particles or a third component into the web.

### SUMMARY OF THE INVENTION

Embodiments of the present invention provide a system comprising two or more die types and/or configurations where multiple fiber streams converge, wherein each die represents different technologies or different configurations of the same technology such that different types and/or sizes of fibers can be co-mingled to form a unique nonwoven structure. Certain embodiments of the present invention are also capable of trapping a third component within a co-mingled meltblown structure. In various embodiments, at least one of the dies in a multi-die system can be a concentric air-type die such that polymers having a low melt flow index can be more readily used in the system. Such polymers can provide good strength and integrity to the meltblown structure formed.

Accordingly, an improved co-mingled hybrid structure can be formed that exhibits advantageous properties over a co-mingled structure formed using a single die type, particularly in relation to filtration properties. As described in more detail below, the systems and methods described herein can provide a nonwoven meltblown material wherein the structure can comprise at least two pluralities of fibers that are at least partially co-mingled. The two or more pluralities of fibers can comprise fibers of different diameters and/or polymer types.

In various embodiments of the present invention, a melt blowing system for the manufacturing of nonwoven fabrics is provided. The system can comprise a collector having a surface positioned to receive a plurality of fibers, a first die in fluid communication with a first liquid polymer supply having a melt flow index of about 500 or lower, the first die comprising a plurality of spinneret nozzles facing the collector surface, wherein the first die has a concentric air design comprising nozzles with individual concentric air jets surrounding each nozzle, and wherein the first die is configured to draw a first plurality of fibers having fiber diameters of less than about 10 microns, a second die in fluid communication with a second liquid polymer supply having a melt flow index of about 500 or higher, the second die comprising a plurality of spinneret nozzles facing the collector surface, the second die comprising spinneret nozzles having smaller capillary diameter than the spinneret nozzles of the first die, and wherein the second die is positioned to draw a second plurality of fibers having fiber diameters of less than about 10 microns such that the first plurality of fibers and the second plurality of fibers form a co-mingled nonwoven web on the collector surface, the co-mingled nonwoven web formed of fibers having varying fiber diameters wherein the first plurality of fibers have a larger average diameter than the second plurality of fibers, and an optional applicator positioned to optionally introduce a third material into the co-mingled web on the collector surface.

In certain embodiments, the second die can have a concentric air design comprising nozzles with individual concentric air jets surrounding each nozzle or the second die can be a single-row-capillary type die design wherein impinging air streams from both sides of a die tip. In various embodiments, the first die can have spinneret nozzles having a capillary diameter in the range of about 500 microns to about 850 microns and the second die can have spinneret nozzles having a capillary diameter in the range of about 100 microns to about 500 microns.

In some embodiments of the melt blowing systems described herein, the first liquid polymer supply can be of the same polymer species as the second liquid polymer supply, and the melt flow viscosity of the first liquid polymer supply can be different from the melt flow viscosity of the second liquid polymer supply. In some embodiments, the first liquid polymer supply can be a different polymer species from the second liquid polymer supply. In certain embodiments, the second polymer supply can comprise a first polyolefin polymer and the first polymer supply can comprise at least one of a polyamide, a polyester, elastomers, a second polyolefin, and combinations thereof. For example, the second polymer supply can comprise polypropylene and the first polymer supply can comprise polybutylene terephthalate or other polyesters including polylactic acid (PLA) or polyethylene terephthalate (PET).

In certain embodiments, the third material can be selected from the group consisting of a particulate material (e.g., various powders including those including nanoparticles), a fibrous material (e.g., a continuous fiber, a sub-micron fiber, a plurality of cut or staple fibers), a plurality of capsules, and combinations thereof. In some embodiments, the third material can be a carded web or a textile fabric comprising a plurality of fibers. The third material can be a film-like material or a paper material in some embodiments.

A nonwoven fabric comprising co-mingled meltblown fibers of different diameters is also provided herein. The nonwoven fabric can comprise a first plurality of fibers formed of a polymer having a melt flow index of about 500 or lower and a second plurality of fibers formed of a polymer having a melt flow index of about 500 or higher. Both the first plurality of fibers and the second plurality of fibers can have fiber diameters of less than about 10 microns and the first plurality of fibers can have a larger average diameter than the second plurality of fibers. In some embodiments, the second polymer can comprise a first polyolefin polymer and the first polymer can comprise at least one of a polyamide, a polyester, elastomers, a second polyolefin, and combinations thereof. For example, the second polymer can comprise polypropylene and the first polymer can comprise polybutylene terephthalate. In various embodiments, the nonwoven fabric can be in the form of pleated or molded filtration media.

A method of forming a nonwoven fabric of co-mingled meltblown fibers is also provided herein. The method can comprise introducing a first liquid polymer and a second liquid polymer into a melt blowing system described herein, drawing a first plurality of fibers from the first die, drawing a second plurality of fibers from the second die, collecting the first plurality of fibers and the second plurality of fibers on the surface of the collector to form a co-mingled meltblown fabric, wherein the co-mingled meltblown fabric can comprise a first plurality of fibers formed of a polymer having a melt flow index of about 500 or lower and a second plurality of fibers formed of a polymer having a melt flow index of about 500 or higher, both the first plurality of fibers and the second plurality of fibers having fiber diameters of less than about 10 microns and wherein the first plurality of fibers have a larger average diameter than the second plurality of fibers. In some embodiments, the nonwoven fabric can be pleatable or moldable.

The invention includes, without limitation, the following embodiments:

Embodiment 1: A melt blowing system for the manufacturing of nonwoven fabrics, comprising: a collector having a surface positioned to receive a plurality of fibers; a first die in fluid communication with a first liquid polymer supply having a melt flow index of about 500 or lower, the first die comprising a plurality of spinneret nozzles facing the collector surface, wherein the first die has a concentric air design comprising nozzles with individual concentric air jets surrounding each nozzle, and wherein the first die is configured to draw a first plurality of fibers having fiber diameters of less than about 10 microns; a second die in fluid communication with a second liquid polymer supply having a melt flow index of about 500 or higher, the second die comprising a plurality of spinneret nozzles facing the collector surface, the second die comprising spinneret nozzles having smaller capillary diameter than the spinneret nozzles of the first die, and wherein the second die is positioned to draw a second plurality of fibers having fiber diameters of less than about 10 microns such that the first plurality of fibers and the second plurality of fibers form a co-mingled nonwoven web on the collector surface, the co-mingled nonwoven web formed of fibers having varying fiber diameters wherein the first plurality of fibers have a larger average diameter than the second plurality of fibers; and an optional applicator positioned to optionally introduce a third material into the co-mingled web on the collector surface;

Embodiment 2: A melt blowing system of any preceding or subsequent embodiment, wherein the second die has a concentric air design comprising nozzles with individual concentric air jets surrounding each nozzle or the second die is a single-row-capillary type die design wherein impinging air streams from both sides of a die tip;

Embodiment 3: A melt blowing system of any preceding or subsequent embodiment, wherein the first die has spinneret nozzles having a capillary diameter in the range of about 500 microns to about 850 microns and the second die has spinneret nozzles having a capillary diameter in the range of about 100 microns to about 500 microns;

Embodiment 4: A melt blowing system of any preceding or subsequent embodiment, wherein the first liquid polymer supply is of the same polymer species as the second liquid polymer supply, and wherein the melt flow viscosity of the first liquid polymer supply is different from the melt flow viscosity of the second liquid polymer supply;

Embodiment 5: A melt blowing system of any preceding or subsequent embodiment, wherein the first liquid polymer supply is a different polymer species from the second liquid polymer supply;

Embodiment 6: A melt blowing system of any preceding or subsequent embodiment, wherein the second polymer supply comprises a first polyolefin polymer and the first polymer supply comprises at least one of a polyamide, a polyester, elastomers, a second polyolefin, and combinations thereof;

Embodiment 7: A melt blowing system of any preceding or subsequent embodiment, wherein the second polymer supply comprises polypropylene and the first polymer supply comprises polybutylene terephthalate;

Embodiment 8: A melt blowing system of any preceding or subsequent embodiment, wherein the third material is selected from the group consisting of a particulate material, a fibrous material, a plurality of capsules, and combinations thereof;

Embodiment 9: A melt blowing system of any preceding or subsequent embodiment, wherein the third material is a carded web or a textile fabric comprising a plurality of fibers, a film-like material, or paper;

Embodiment 10: A melt blowing system for the manufacturing of nonwoven fabrics, comprising: a first die, wherein the first die can be configured to form a co-mingled web, wherein the first die is a multiple row concentric-air type die design such that it features nozzles with individual concentric air jets, and wherein the first die is configured to draw a first fiber comprising a first polymer having a first melt viscosity; a second die, wherein the second die can be configured to form the co-mingled web, and wherein the second die is a multiple row concentric-air type die design such that it features nozzles with individual concentric air jets, and wherein the second die is configured to draw a second fiber comprising a second polymer having a second melt viscosity; a collector positioned to receive the first fiber and the second fiber; and an optional applicator configured to optionally introduce a third material into the co-mingled web, wherein the first die comprises rows of capillaries, each capillary having a diameter in the range of about 100 microns to about 500 microns; and wherein the second die comprises rows of capillaries, each capillary having a diameter in the range of about 500 microns to about 850 microns;

Embodiment 11: A nonwoven fabric of any preceding or subsequent embodiment, wherein the nonwoven fabric comprises co-mingled meltblown fibers of different diameters comprising a first plurality of fibers formed of a polymer having a melt flow index of about 500 or lower and a second plurality of fibers formed of a polymer having a melt flow index of about 500 or higher, both the first plurality of fibers and the second plurality of fibers having fiber diameters of less than about 10 microns and wherein the first plurality of fibers have a larger average diameter than the second plurality of fibers;

Embodiment 12: A nonwoven fabric of any preceding or subsequent embodiment, wherein the second polymer comprises a first polyolefin polymer and the first polymer comprises at least one of a polyamide, a polyester, elastomers, a second polyolefin, and combinations thereof;

Embodiment 13: A nonwoven fabric of any preceding or subsequent embodiment, wherein the second polymer comprises polypropylene and the first polymer comprises polybutylene terephthalate;

Embodiment 14: A nonwoven fabric of any preceding or subsequent embodiment, wherein the nonwoven fabric is in the form of pleated or molded filtration media;

Embodiment 15: A method of forming a nonwoven fabric of co-mingled meltblown fibers of any preceding or subsequent embodiment, comprising introducing a first liquid polymer and a second liquid polymer into the melt blowing systems described herein; drawing a first plurality of fibers from the first die; drawing a second plurality of fibers from the second die; collecting the first plurality of fibers and the second plurality of fibers on the surface of the collector to form a co-mingled meltblown fabric, wherein the co-mingled meltblown fabric comprises a first plurality of fibers formed of a polymer having a melt flow index of about 500 or lower and a second plurality of fibers formed of a polymer having a melt flow index of about 500 or higher, both the first plurality of fibers and the second plurality of fibers having fiber diameters of less than about 10 microns and wherein the first plurality of fibers have a larger average diameter than the second plurality of fibers;

Embodiment 16: A method of forming a nonwoven fabric of co-mingled meltblown fibers of any preceding or subsequent embodiment, wherein the nonwoven fabric is pleatable or moldable.

In various embodiments of the present invention, a melt blowing system for the manufacturing of nonwoven fabrics is provided, comprising: a first die, wherein the first die can be configured to form a co-mingled web, and wherein the first die is a concentric-air design such that it features nozzles with individual concentric air jets, and wherein the first die is configured to draw a first fiber comprising a first polymer having a first melt viscosity; a second die, wherein the second die can be configured to form the co-mingled web, and wherein the second die is a single-row-capillary type die design wherein impinging air streams from both sides of a die tip are configured to draw a second fiber comprising a second polymer having a second melt viscosity; and a collector positioned to receive the first fiber and the second fiber; and an optional applicator configured to optionally introduce a third material into the co-mingled web.

In some embodiments, the first die can comprise comprises capillaries in the range of about 500 microns to about 850 microns. In certain embodiments, the second die can comprise capillaries in the range of about 100 microns to about 500 microns. In various embodiments, the first die and the second die can comprise similarly sized capillaries in the range of about 100 microns to about 850 microns.

In various embodiments of the system described herein, the first polymer can be of the same species as the second polymer, and the first melt viscosity can be different from the second melt viscosity. The melt viscosities, expressed as melt flow index (MFI) or otherwise known as melt flow rate (MFR), can range from about 30 to about 7000, for example. In certain embodiments, the first polymer can be different from the second polymer. In various embodiments, the first melt flow index can be lower than the second melt flow index. For example, the first melt flow index can be 500 while the second melt flow index can be 1600. In various embodiments, the second polymer supply can comprise a first polyolefin polymer and the first polymer supply can comprise at least one of a nylon, a polyester, elastomers, a second polyolefin, and combinations thereof. For example, the second polymer supply can comprise polypropylene and the first polymer supply can comprise polybutylene terephthalate or other polyesters including polylactic acid (PLA) or polyethylene terephthalate (PET).

In some embodiments, the first die can comprise a first nozzle size and a first nozzle geometry. The second die can comprise a second nozzle size and a second nozzle geometry. In certain embodiments, the first nozzle size and the first nozzle geometry are different from the second nozzle size and the second nozzle geometry.

Embodiments of the present invention also include a melt blowing system for the manufacturing of nonwoven fabrics comprising a first die, wherein the first die can be configured to form a co-mingled web, wherein the first die is a single-row-capillary type die design wherein impinging air streams from both sides of a die tip are configured to draw a first fiber comprising a first polymer having a first melt viscosity, a second die, wherein the second die can be configured to form the co-mingled web, and wherein the second die is a single-row-capillary type die design wherein impinging air streams from both sides of a die tip are configured to draw a second fiber comprising a second polymer having a second melt viscosity, a collector positioned to receive the first fiber and the second fiber, and an optional applicator configured to optionally introduce a third material into the co-mingled web. In some embodiments, the first die comprises multiple rows of capillaries, each capillary having a diameter in the range of about 500 microns to about 850 microns, and the second die comprises multiple rows of capillaries, each capillary having a diameter in the range of about 100 microns to about 500 microns. In certain embodiments, the first die comprises a first plurality of capillaries, the second die comprises a second plurality of capillaries, and the first plurality of capillaries can be arranged in a different pattern from the second plurality of capillaries.

In various embodiments of the present invention, a melt blowing system is provided wherein the system comprises a first die, wherein the first die can be configured to form a co-mingled web, wherein the first die is a multiple row concentric-air type die design such that it features nozzles with individual concentric air jets, and wherein the first die is configured to draw a first fiber comprising a first polymer having a first melt viscosity, a second die, wherein the second die can be configured to form the co-mingled web, and wherein the second die is a multiple row concentric-air type die design such that it features nozzles with individual concentric air jets, and wherein the second die is configured to draw a second fiber comprising a second polymer having a second melt viscosity, a collector positioned to receive the first fiber and the second fiber; and an optional applicator configured to optionally introduce a third material into the co-mingled web. In some embodiments, the first die comprises multiple rows of capillaries, each capillary having a diameter in the range of about 500 microns to about 850 microns, and the second die comprises multiple rows of capillaries, each capillary having a diameter in the range of about 100 microns to about 500 microns. In certain embodiments, the first die comprises a first plurality of capillaries, the second die comprises a second plurality of capillaries, and the first plurality of capillaries can be arranged in a different pattern from the second plurality of capillaries.

In various embodiments of the melt blowing system, the third material can be selected from the group consisting of a powder, a continuous fiber, an electrospun fiber, a plurality of cut fibers, a plurality of staple fibers, a plurality of particles, a plurality of nanoparticles, a plurality of capsules, and combinations thereof. In some embodiments, the third material can be a carded web comprising a plurality of fibers. In some embodiments, the plurality of fibers can measure about 1 micron or less in diameter. Alternatively, the plurality of fibers can measure about 1 micron or more in diameter. In certain embodiments, the plurality of fibers can be macro fibers comprising about 6 lobes to about 50 lobes, thereby giving the fibers high surface area.

A pleatable/moldable single-layer nonwoven fabric comprising co-mingled meltblown fibers of different diameters is also provided herein. In some embodiments, a filtration media can be formed from the pleatable/moldable single-layer nonwoven fabric.

A method of forming a pleatable/moldable single-layer nonwoven fabric is also provided. Embodiments of the method can comprise positioning a first die and a second die to form a co-mingled web; wherein the first dies is a concentric-air design such that it features nozzles with individual concentric air jets, and wherein the first die is configured to draw a first fiber comprising a first polymer having a first melt viscosity; and wherein the second die is a single-row-capillary type die design wherein impinging air streams from both sides of a die tip are configured to draw a second fiber comprising a second polymer having a second melt viscosity. The method can further comprise positioning a collector to receive the first fiber and the second fiber. Optionally, the method can comprise positioning an applicator configured to optionally introduce a third material into the co-mingled web.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### BRIEF DESCRIPTION OF THE DRAWINGS

Having thus described the present disclosure in general terms, reference will now be made to the accompanying drawings, which are not necessarily drawn to scale, and wherein:

FIG. 1 is a schematic drawing illustrating the melt blowing stream of fibers being deposited onto a drum collector;

FIG. 2 is a schematic drawing of a system having dual melt blowing dies and a deposition slot for converging fiber streams and trapping materials deposited therein;

FIG. 3 is a schematic drawing of an embodiment of a filter formed from a single-layer pleatable nonwoven fabric described herein;

FIG. 4 is a schematic drawing including FIGS. 4A-4C illustrating meltblown fiber streams with varying degrees of convergence;

FIG. 5A is a schematic drawing illustrating a concentric-air die type technology having concentric air jets surrounding each nozzle;

FIG. 5B is a schematic drawing illustrating an impinging air die type technology having impinging air streams from both sides of a die tip;

FIG. 6 is a schematic drawing of a melt blowing system comprising two meltblown dies having different capillary diameters;

FIGS. 7A-7D are scanning electron microscope (SEM) images of meltblown fabrics made from a multi-die system with a high degree of converging;

FIGS. 8A-8D are SEM images of meltblown fabrics made from a multi-die system with a medium degree of converging;

FIGS. 9A-9D are SEM images of meltblown fabrics made from a multi-die system with a low degree of converging;

FIGS. 10A-10B are SEM images of meltblown fabrics made from a multi-die system with a high degree of converging;

FIGS. 11A-11B are SEM images of meltblown fabrics made from a multi-die system with a low degree of converging;

FIG. 12 is a graph comparing filtration performance of samples produced with a dual die apparatus to filtration performance of samples produced with a single die system;

FIGS. 13A-13D are SEM images of meltblown fabrics made from a multi-die system with a high degree of converging;

FIGS. 14A-14D are SEM images of meltblown fabrics made from a multi-die system with a low degree of converging;

FIG. 15 is a graph comparing filtration performance of polypropylene samples produced with a dual die apparatus to filtration performance of polypropylene/PBT samples produced with a dual die apparatus; and

FIGS. 16A and 16B are photographs of meltblown fabrics made from a multi-die system that have been pleated.

### DETAILED DESCRIPTION

The present inventions will now be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural referents unless the context clearly dictates otherwise.

Embodiments of the present invention provide a multiple array of melt blowing dies for producing co-mingled fibrous webs. As used herein, the term “co-mingled” is used to refer to a fibrous web comprising two or more pluralities of fibers at least partially mixed. The degree to which the two or more pluralities of fibers are co-mingled (i.e., mixed/blended) can be varied as described in more detail below. In some embodiments, other materials can be introduced into the co-mingled fibrous web by depositing the material onto the converging fiber streams.

As used herein, the term “fiber” is defined as a basic element of textiles which has a high aspect ratio of, for example, at least about 100 times. In addition, “filaments/continuous filaments” are continuous fibers of extremely long lengths that possess a very high aspect ratio. “Staple fibers” are cut lengths from continuous filaments. The term “multicomponent fibers” refers to fibers that comprise two or more polymers that are different by physical or chemical nature including bicomponent fibers. The term “nonwoven” as used herein in reference to fibrous materials, webs, mats, batts, or sheets refers to fibrous structures in which fibers are aligned in an undefined or random orientation.

The fibers according to the present invention can vary, and include fibers having any type of cross-section, including, but not limited to, circular, rectangular, square, oval, triangular, and multi-lobal. In certain embodiments, the fibers can have one or more void spaces, wherein the void spaces can have, for example, circular, rectangular, square, oval, triangular, or multi-lobal cross-sections. The fibers may be selected from single-component (i.e., uniform in composition throughout the fiber) or multicomponent fiber types including, but not limited to, fibers having a sheath/core structure and fibers having an islands-in-the-sea structure, as well as fibers having a side-by-side, segmented pie, segmented cross, segmented ribbon, or tipped multi-lobal cross-sections.

The means of producing a nonwoven web can vary. In general, nonwoven webs are typically produced in three stages: web formation, bonding, and finishing treatments. Web formation can be accomplished by any means known in the art. For example, webs may be formed by a drylaid process, a spunlaid process, or a wetlaid process. In various embodiments of the present invention, the nonwoven web is made by a melt blowing process.

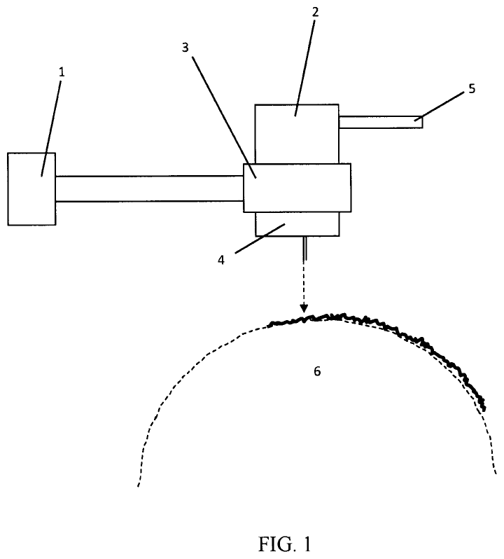

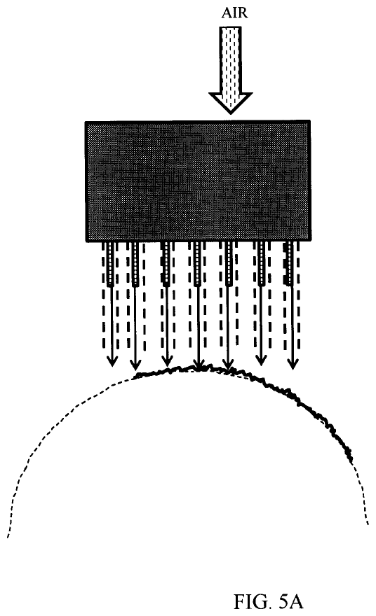

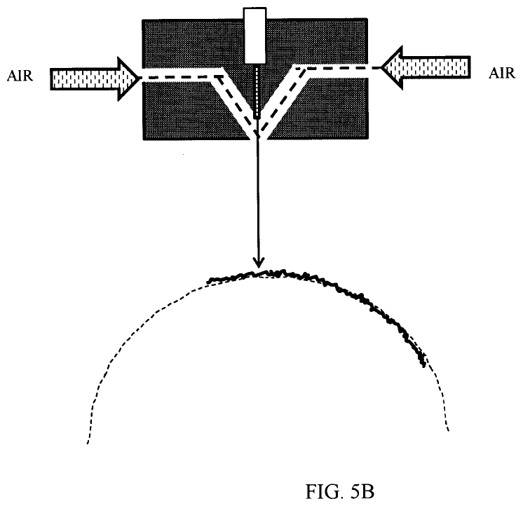

Melt blowing technology is a melt-spun process that can be used to produce microfibers by injecting a molten polymer stream into high velocity gas jets. As illustrated in FIGS. 1, 5A and 5B, for example, a high-velocity gas jet impinges upon the polymer as it emerges from the spinneret 4. An extruder 1 can feed a polymer to a first die 3 and through spinneret 4. Air can come in the air intake 5 and into the air manifold 2. High pressure air is then used to draw the polymer into a fiber which can be collected on collector 6. The drag force caused by the air attenuates the fiber rapidly, and reduces its diameter as much as a hundred times from the nozzle diameter. Melt blown webs are typically reported to have fibers in the range of 0.1-10 μm, high surface area per unit weight, high insulation value, self-bonding, and high barrier properties yet breathability.

The fiber formation process in melt blowing can be critically dependent on the aerodynamics of the process. For example, the drag force due to the high-speed air is the main cause of fiber attenuation. Primary air systems include high-speed air jets that impinge upon the molten polymer streams once they exit the die. Secondary cross flow air streams can be employed to provide cold or ambient air to quench the extruded filaments. See, e.g., U.S. Pat. No. 5,080,569 to Gubernick et al., which is incorporated by reference herein. See also the secondary air quenching system for a spun-bonding die system disclosed in U.S. Pat. No. 5,098,636 to Balk, herein incorporated by reference. Accelerating the air below the die face by recessing the die tip above the die face in order to increase the air velocity can thereby increase the drag force and fiber attenuation. See, e.g., U.S. Pat. Pub. No. 2003/0173701 to Arseneau et al. It has been shown that for such inset dies, the maximum turbulence intensity occurs right at the die face, where the constriction is at its smallest and where a molten polymer fiber might start to vibrate and stick to the die tip. The use of a cold secondary air stream followed by an air constrictor can be used to increase the fiber attenuation after fibers solidified. See, e.g., WO 2006/037371, which is herein incorporated by reference. However, such rapid cooling of the fibers near the die face can result in a larger fiber diameter, and the cross flow direction can make the fibers sticks or accumulate on the edges of the air constrictors.

Melt blowing is generally capable of providing fibers with relatively small diameters. Diameter and other properties of meltblown fibers can be tailored by modifying various process parameters (e.g., die design (discussed in more detail below), die capillary size, polymer throughput, air characteristics, collector placement, and web handling). Die capillary size refers to the diameter of the holes in a die through which a polymer is fed during a melt blowing process. A larger die capillary diameter can contribute to forming fibers having larger diameters. Polymer throughput can be measured in grams of polymer per hole per minute (ghm). A larger throughput can contribute to producing coarser (i.e., larger diameter) fibers. Attenuating the air pressure affects fiber size, as higher pressures typically yield finer fibers (e.g., up to about 5 microns, such as about 1-5 microns) and lower pressures yield coarser fibers (e.g., up to about 30 microns, such as about 10-30 microns).

In certain embodiments of the present invention, the nonwoven web comprises meltblown fibers having average diameters in the range of about 1 to about 10, e.g., about 2 to about 5 microns. In some embodiments, the mean flow pore size of a meltblown nonwoven web can be about 20 microns or less, about 10 microns or less, about 8 microns or less, about 5 microns or less, about 2 microns or less, or about 1 micron or less. The meltblown fibers typically comprise single component fibers.

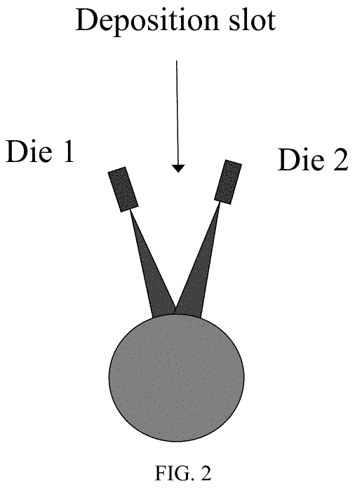

As disclosed herein, a multiple array of melt blowing dies can be used for producing co-mingled fibrous webs. See, for example, the system illustrated in FIG. 2. As shown in FIG. 1, for example, the system can comprise a first extruder to feed a first polymer to a first die and a second extruder to feed a second polymer to a second die. The system can further comprise a collector positioned to receive fibers from the first and second dies. The first and second die can be positioned such that a co-mingled web is formed on the collector. Optionally, the system can comprise an applicator configured to optionally introduce a third material into the co-mingled web.

Embodiments of the present invention provide a system using two or more die types and/or configurations where multiple fiber streams converge, wherein each die represents different technology such that different types and/or sizes of fibers can be co-mingled to form a unique hybrid nonwoven structure. Conventional meltblown die technologies can be roughly classified into two categories: (1) single-row-capillary or impinging air type die design, which is also well-known as Exxon design; (2) multiple-row-concentric-air type design, which is also known as Biax/Schwarz design.

As illustrated in FIG. 5B, for example, a conventional meltblown technology (i.e., single-row-capillary or impinging-air type die design) has a single row of spinning capillaries with impinging air streams from both sides of the die tip to draw the fibers. The safe operation pressure of this process is less than about 100 bar, for example. The concentric air-type meltblown die technology features multiple rows of spinning nozzles with individual concentric air jets to attenuate the fibers. It also tolerates high melt pressures at the spinneret and therefore can utilize higher viscosity polymers with a wide operation window. See, e.g., R. Zhao, “Melt Blowing Polyoxymethylene Copolymer,” International Nonwoven Journal, Summer 2005, pp. 19-21 (2005), herein incorporated by reference. As such, the different die types can return different sized fibers and utilize different polymers.

Currently available polymers of interest have melt flow rates mostly lower than 100 compared to common meltblown grade polypropylene resins that have melt flow rates higher than 100 and as much as 2400, for example. In other words, one can expect high melt pressure during melt blowing of these polymers. A concentric-air design die type can be used with polymers with lower melt flow rates. For example, a concentric-air design die type can be used to draw polymers with a melt flow of about 1600 to about 30 melt flow or less. A concentric-air design die type can comprise capillaries each having a diameter that ranges from about 100 to about 850 microns.

In various embodiments of the present invention, an array of dies are arranged in a co-mingled system, wherein the system comprises a first die and a second die. The first die can be a concentric-air type die design and the second die can be a concentric-air type die design or a single-row-drilled-hole type die design. Use of the first die in the form of a concentric air-type die is advantageous to form larger diameter fibers on a co-mingled structure, particularly where the larger diameter fibers (e.g., polybutylene terephthalate fibers) are constructed of a polymer having a melt flow index of 500 or lower. The second die is used to form smaller diameter fibers (e.g., polypropylene fibers), which can be for example, adapted primarily for purposes of providing good filtration performance in the co-mingled structure. Advantageously, the melt flow index of the smaller diameter fibers can be about 500 or higher.

The dies can be arranged to allow a wide range of angles between each die and the collector from about 10 to about 90 degrees. The distance between the two dies and the collector surface and the angle between the dies can also be adjusted to allow various degrees of co-mingling. For example, the overall die to collector distance can range from about 100 mm to about 500 mm.

In some embodiments of a co-mingled meltblown system, the system can comprise a first die and a second die, wherein the first die can have a first capillary size and the second die can have a second capillary size. In certain embodiments, the first die comprises capillaries in the range of about 500 microns to about 850 microns in order to produce larger diameter fibers. In certain embodiments, the second die comprises capillaries in the range of about 100 microns to about 500 microns in order to produce finer fibers.

In some embodiments of a co-mingled meltblown system, the system can comprise a concentric air-type die where capillaries have different sizes either in rows or in an alternate pattern. The concentric air-type die is advantageously configured to produce larger diameter fibers to add strength to a co-mingled meltblown structure, such as a concentric air-type die with capillaries sized about 500 to about 600 microns. The system can further comprise a second concentric air-type die or a single-row-capillary type die with a capillary size that produces finer fibers (e.g., capillaries sized about 100 to about 300 microns). In a multi-rowed concentric air type die design, it is also possible to vary the capillary size between rows of nozzles such that different size fibers are provided by the same single die.

In some embodiments, the first die can comprise a first nozzle size and a first nozzle geometry. The second die can comprise a second nozzle size and a second nozzle geometry. In certain embodiments, the first nozzle size and the first nozzle geometry are different from the second nozzle size and the second nozzle geometry.

The manner in which the two meltblown polymer streams converge can determine the level of co-mingling (e.g., a fully co-mingled structure or a structure composed of two layers with only some of the fibers being co-mingled). As illustrated in FIG. 4A, for example, at about 10 degrees to about 30 degrees, the webs can be layered with some of their respective fibers co-mingled. At higher angles, the degree of co-mingling increases, as demonstrated in FIGS. 4B and 4C, for example.

In various embodiments of the melt blowing system described herein, the two or more dies can be arranged to vary the degree of co-mingling between the fibers, as illustrated in FIG. 6, for example. The multi-die melt blowing system 60 can comprise a first die 62 and a second die 64. The first die can be designed to produce finer fibers and the second die can be designed to produce coarser fibers, for example. Dies having different sized capillaries can be used depending on the polymer used and the desired type of meltblown fibers to be produced (e.g., fine fibers or coarse fibers). Varying the alignments of the two dies can control the degree of converging between the two fiber types. In a first alignment, die 62 can be arranged such that a low converging stream A is provided from die 62. With the low degree of convergence setting, fibers from the second melt blowing die 64 are collected on the forming surface (e.g., the drum collector 64) first and then fibers from the first die 62 are laid over the fibers from the second melt blowing die 64. A convergence angle θ can be defined as the angle between the two streams coming from the two melt blowing dies. The convergence angle θ used for this low convergence setting can be about 15° to about 25°, for example. In a second alignment, melt blowing die 62 can be arranged such that a medium converging stream B is provided from die 62. The medium converging stream B partially intermingles with stream D coming from the second melt blowing die 64 just before or approximately at the location where the streams met the drum collector 66. The convergence angle θ used for this medium convergence setting can be about 35° to about 45°, for example. In a third alignment, melt blowing die 62 can be arranged such that a high converging stream C is provided from die 62. The high converging stream C intermingles with stream D coming from the second melt blowing die 64 in the air before the two streams hit the surface of the drum collector 66 such that a high amount of co-mingling occurs between the two streams. The convergence angle θ used for this high convergence setting can be about 50° to about 60°, for example.

In various embodiments of the present invention, at least one thermoplastic polymer and/or a blend thereof can be used to fabricate the co-mingled nonwoven structures described herein. Fibers used in forming nonwoven co-mingled webs can include, for example, one or more thermoplastic polymers selected from the group consisting of: polyesters, co-polyesters, polylactic acid, polyamides, polyolefins, polyacrylates, thermoplastic liquid crystalline polymers, elastomers such as PBAX®, ELASTOLLAN®, KRATON® and HYTREL®, and combinations thereof. In some embodiments a single layer meltblown structure can be fabricated from fibers comprising polyester, co-polyester, polypropylene, polyethylene, or polyamide type polymeric materials, or combinations thereof. In various embodiments, at least about 50%, or about 60%, or about 70%, or about 80%, by weight of the nonwoven web comprises a polyamide, polypropylene, polybutylene terephthalate, polyvinylidene fluoride (PVDF), perfluoroalkoxy alkane (PFA), ELASTOLLAN®, KRATON®, HYTREL®, or a combination thereof. Other fiber grade polymers can also be used to form the nonwoven webs described herein. The polymer compositions used to form the fibers of the co-mingled structures of the invention can optionally include other components not adversely affecting the desired properties thereof. Examples include, without limitation, antioxidants, stabilizers, particulates, pigments, and the like. These and other additives can be used in conventional amounts.

In various embodiments, the first polymer fed to the first die is of the same species as the second polymer fed to the second die. In certain embodiments, the first polymer is different from the second polymer. In some embodiments, a first polymer component having a first melt viscosity can be fed through a first die and a second polymer component having a second melt viscosity can be fed through a second die. In certain embodiments, the first melt viscosity can be different from the second melt viscosity such that the first melt viscosity is either higher or lower than the second melt viscosity. In certain embodiments, the first melt viscosity can be the same as (i.e., equal to) the second melt viscosity. The melt viscosities, expressed as melt flow index, can range from about 30 to about 2400, for example. MFI/MFR can be calculated using ISO 1133:2005 and expressed in grams per 10 minutes. Higher melt flows can be possible by adding, for example, an additive such as peroxide to unzip the polymer and reduce its molecular weight. Accordingly, melt flows as high as 7000 can be possible.

In a preferred embodiment, for example, the polymer fed to the second die (e.g., used to form the finer fibers) can be a first polyolefin and the polymer fed to the first die (e.g., used to form the coarser fibers) can comprise at least one of a polyamide, a polyester, elastomers, a second polyolefin, and combinations thereof. The melt viscosity of the polymer used for the coarser fibers can be higher than the melt viscosity of the polymer used to form the finer fibers. In a preferred embodiment, a liquid polymer supply having a melt flow index of about 500 or lower (e.g., about 400 or lower or about 300 or lower such as about 10 to about 400) can be fed to the first die to produce coarser fibers and a second liquid polymer supply having a melt flow index of about 500 or higher (e.g., about 600 or higher or about 700 or higher such as about 500 to about 2400) can be fed to the second die to produce finer fibers. In certain embodiments, the first die can be a concentric air-type die configured to produce coarser fibers from polymers having a melt flow index of about 500 or lower.

In some embodiments, a third material can be deposited into an individual fiber stream and/or the co-mingled fiber stream such that the third material would be “inter-locked” into the structure. If the two nozzles are converging, the process allows for the deposition of fibers (e.g., nano and/or micro fibers (i.e., fibers with a diameter in the range of several μm down to below 100 nm), continuous fibers, multilobal fibers, a plurality of cut fibers, sub-micron fibers such as those produced by electrospinning or other means, a plurality of staple fibers, and the like), particles (including nanoparticles), a web of fibers (e.g., a carded web or another textile fabric), absorbents, other materials like films or paper, and combinations thereof into the converging streams, for example. The third material can then be co-mingled with the fibers formed from the first die and the second die. For example, an electrospun fiber can be deposited onto the converging stream to form a co-mingled structure composed of fine and coarse meltblown fibers (e.g., from the concentric air-type die and single-row-capillary type die, respectively) as well as electrospun fibers in the middle of the converging stream. Since the fibers are still tacky and not completely solidified, the deposited materials form a bond with the fibers.

Various embodiments of the present invention describe a method of forming a pleatable/moldable single-layer nonwoven fabric. Embodiments of the method can comprise positioning a first die and a second die to form a co-mingled web, wherein the first dies is a single-row-drilled-hole type die design wherein impinging air streams from both sides of a die tip are configured to draw a first fiber comprising a first polymer having a first melt viscosity, and wherein the second die is a concentric air design such that it features nozzles with individual concentric air jets, and wherein the second die is configured to draw a second fiber comprising a second polymer having a second melt viscosity. The position of each die relative to each other and the collector can control the degree of co-mingling of the extruded fibers as explained above.

The method can further comprise positioning a collector to receive the first fiber and the second fiber. Optionally, the method can comprise positioning an applicator configured to optionally introduce a third material into the co-mingled web. The die collector distance is adjustable to allow the degree of consolidation of the webs to be set to a desired amount. For example, the distance can be adjusted from about 10 cm to about 50 cm after the two or more layers of webs are co-mingled.

In a preferred embodiment, a method of forming a nonwoven fabric of co-mingled meltblown fibers can comprise introducing a first liquid polymer and a second liquid polymer into the melt blowing systems described herein, drawing a first plurality of fibers from the first die and drawing a second plurality of fibers from the second die. The method can further comprise collecting the first plurality of fibers and the second plurality of fibers on the surface of the collector to form a co-mingled meltblown fabric. The co-mingled meltblown fabric can comprise a first plurality of fibers formed of a polymer having a melt flow index of about 500 or lower and a second plurality of fibers formed of a polymer having a melt flow index of about 500 or higher, for example. Both the first plurality of fibers and the second plurality of fibers can have fiber diameters of less than about 10 microns, but the first plurality of fibers can have a larger average diameter (e.g., about 5 to about 10 microns) than the second plurality of fibers (e.g., about 1 to about 5 microns). Fiber diameters can be determined by visual inspection of the fibers using SEM images. Fiber diameters noted herein refer to individual fibers rather than agglomerated sections of multiple fibers within the fabric where greater diameters may be observed.

Advantageously, the present invention provides a method and system for forming co-mingled meltblown fabrics that can be formed from polymers having different melt flow index and different average fiber diameter, with the coarser fiber component (e.g., a polyester such as PBT) providing increased strength to the co-mingled web and the finer fiber component (e.g., a polyolefin such as PP) providing good filtration performance. The use of a concentric-air design die to produce the coarser fiber component enables one to use polymers of higher melt flow index at good throughput rates. It has been surprisingly discovered that forming co-mingled meltblown fabrics according to the invention can provide filtration media exhibiting good filtration performance. In certain embodiments, the co-mingled meltblown fabric is pleatable/moldable without the use of additional scrims or other structures that can complicate manufacturing.

In various embodiments, the meltblown system is capable of forming a pleatable/moldable single-layer nonwoven fabric comprising co-mingled meltblown fibers of different diameters. In a preferred embodiment, a nonwoven fabric comprising co-mingled meltblown fibers of different diameters can be formed from the methods and systems described herein. The nonwoven fabric can comprise first plurality of fibers formed of a polymer having a melt flow index of about 500 or lower and a second plurality of fibers formed of a polymer having a melt flow index of about 500 or higher. Both the first plurality of fibers and the second plurality of fibers can have fiber diameters of less than about 10 microns, but the first plurality of fibers can have a larger average diameter than the second plurality of fibers.

The relative amount of the coarse and fine fiber components can vary, although it is advantageous for the coarse fiber component to be the predominate fiber component in the co-mingled meltblown fabric from a weight perspective. For example, the course fiber component can be present in an amount of at least about 50 weight percent, such as at least about 55 or at least about 60 weight percent. In certain embodiments, the coarse fiber component is present in an amount of at least about 70 weight percent or at least about 80 weight percent, based on the total weight of the fabric.

Basis weight (W) and thickness (t) of the meltblown webs can be measured. For example, Standard Test Methods for Mass Per Unit Area (Weight) of Fabric (ASTM D3776) can be used to measure the basis weight of the fabrics described herein. In various embodiments of the present invention, co-mingled meltblown fabrics can have a basis weight of about 40 to about 150, about 40 to about 90, about 40 to about 50, or about 40 to about 45 grams per square meter (gsm). In various embodiments of the present invention, co-mingled meltblown fabrics can have a thickness of about 300-1200 μm, about 400-800 μm, or about 400-600 μm.

Solidity of the fabrics can also be calculated. Solidity (α) can be calculated using the following equation:

$$α = \frac{W}{{ρ}_{f} \times t}$$

where ρ_{f} is fiber density.
In various embodiments of the present invention, co-mingled meltblown fabrics can have a solidity of about 4 to about 20%, about 5 to about 15%, or about 6 to about 12%.

In addition, filtration properties of the fabrics can be measured. Filtration performance can be evaluated with TSI 3160 filter tester at face velocity of 5.3 cm/sec, for example. 0.3 micron particles can be used to measure filtration efficiency. Filtration efficiency (E), pressure drop (Δp) and quality factor (Q.F.) can be recorded. Quality factor is defined as:

$$Q . F . = - \frac{ln P}{Δ p}$$

where P is penetration (P=1−E/100).

In various embodiments of the present invention, co-mingled meltblown fabrics can have a filtration efficiency of about 20 to about 50 percent at a pressure drop of about 5 to about 20 Pa. Co-mingled meltblown fabrics can have a filtration efficiency of about 25 to about 55 percent at a pressure drop of about 20 to about 40 Pa, for example. Co-mingled meltblown fabrics can have a filtration efficiency of about 35 to about 55 percent at a pressure drop of about 40 to about 60 Pa, for example. In various embodiments of the present invention, co-mingled meltblown fabrics can have a quality factor of about 0.01 to about 0.05 Pa⁻¹, about 0.01 to about 0.025 Pa⁻¹, or about 0.01 to about 0.015 Pa⁻¹. In certain embodiments, the quality factor can be expressed as at least about 0.010 Pa⁻¹, or at least about 0.014 Pa⁻¹, or at least about 0.020 Pa⁻¹.

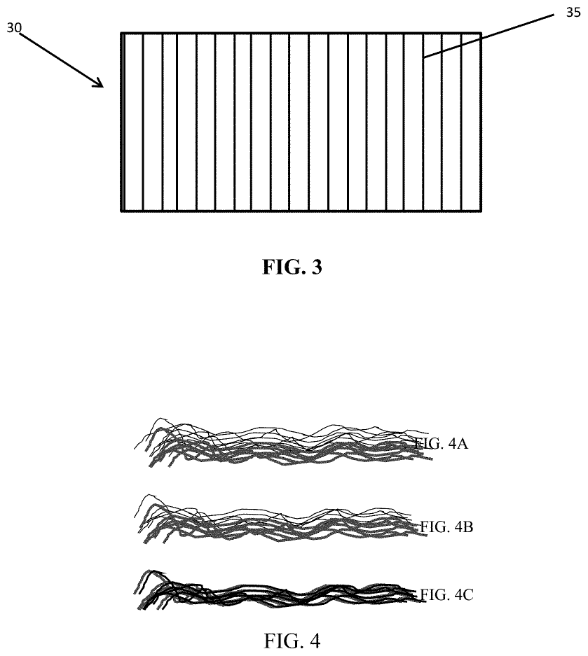

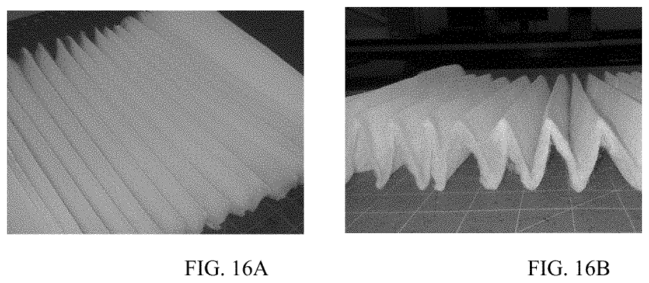

In some embodiments, a filtration media can be formed from the pleatable/moldable single-layer nonwoven fabric. See for example, the filter 30 with pleats 35 illustrated in FIG. 3. See also FIG. 16 illustrating a pleated co-mingled nonwoven fabric of the present invention.

### EXPERIMENTAL

The present invention is more fully illustrated by the following examples, which are set forth to illustrate the present invention and are not to be construed as limiting thereof.

### Example 1

Co-mingled fine and coarse fibers can be formed by having two or more dies that have capillaries that are different in size. Alternatively, two or more similar or dissimilar dies can be used but the capillary throughput is adjusted such that fine and coarse fibers are formed. In a preferred embodiment, two different die types are used—one based on a concentric air design and the other based on single-row-drilled-hole type die design.

### Example 2

Co-mingled meltblown and electrospun webs can be formed by having two or more meltblown dies and a stream of electrospun fibers that are injecting the electrospun fiber webs into the meltblown fiber streams. The drum collector acts as the ground for the Electrospinning system. The advantage of such a system is that it can form a larger fiber layer (for pleating/molding) and also for pre-filtering using a concentric air-type die and a polymer such as PET, PBT and the like, and a layer of electrospun fibers that are deposited into the middle of the of the two converging meltblown fiber streams. As such, a third layer of fibers can be inserted between and/or at least partially co-mingled with layers of fine fiber.

### Example 3

Co-mingled cut fibers and meltblown fibers can be formed by having two or more meltblowing dies and depositing cut fibers in the form of loose fibers and/or staple fiber webs by depositing fibers and/or the web into the converging stream of meltblown fibers. The fibers are deposited by using a similar technique to depositing particles in powder coating units where they are dosed and added using a rotating brush or collector.

### Example 4

Co-mingled particles, pulp and the like and meltblown fibers can be formed by having two or more meltblowing dies and depositing powders, particles, and/or pulp into the converging stream of meltblown fibers. The particles can be activated carbon, Metal Organic Frame Works (MOFs), ZIFs, ceramic, metal oxides, and the like.

### Example 5

Co-mingled fine and coarse fibers can be formed by having two or more similar die types that have capillaries that are different in size. In a preferred embodiment, two similar die types are used—one die based on a concentric air design with capillaries in the range of 500 to 850 microns and a second die also based on a concentric air design with capillaries in the range of about 100 to about 500 microns.

### Example 6

Co-mingled fine and coarse fibers can be formed by having two or more similar die types that have capillaries that are different in size. In a preferred embodiment, two similar die types are used—one die based on a single-row-impinging-air design with a single row of capillaries in the range of 500 to 850 microns and a second die also based on a single-row-capillary type design with capillaries in the range of about 100 to about 500 microns.

### Example 7

Co-mingled fine and coarse fibers can be formed by having two or more similar die types that have capillaries that are different in size. In a preferred embodiment, two similar die types are used—one die based on a single-row-impinging-air design with a single row of capillaries with 20 to 30 capillaries per inch with diameters in the range of 500 to 850 microns and a second die also based on a single-row-capillary type design with 30 to 50 capillaries per inch and with diameters in the range of about 100 to about 500 microns.

### Examples 8-22

Examples of co-mingled meltblown structures were produced with a multi-die melt blowing system having two concentric air-type die types, as illustrated in FIG. 6, for example. The multi-die melt blowing system 60 comprises two meltblown dies where one melt blowing die 62 has capillaries with a diameter of 228 μm to form fine fibers and a second die 64 has capillaries with a diameter of 508 μm to form coarse fibers. Dies having different sized capillaries can be used depending on the polymer used and the desired type of meltblown fibers to be produced (e.g., fine fibers or coarse fibers).

Varying the alignments of the two dies controls the degree of converging, as illustrated in FIG. 6, for example. A convergence angle θ can be defined as the angle between the two streams coming from the two melt blowing dies. The convergence angle θ used for this low convergence setting can be about 15° to about 25°. The convergence angle θ used for this medium convergence setting can be about 35° to about 45°The convergence angle θ used for this high convergence setting can be about 50° to about 60°.

Examples 8-22 utilize polypropylene resin METOCENE® MF650 W with melt flow rate of 500 supplied by Lyondellbaseell. The same polymer was used for both dies. Air flow and throughput were varied to change fiber diameters. The degree of convergence was also varied. Detailed production conditions of examples 8-22 are provided in Table 1 below. The fiber ratio is reported as the mass/weight ratio of the two plurality of fibers forming the co-mingled web.

TABLE 1
Production Conditions of Examples 8-22

| | | Die 1: | | | Die 2: | | | | |
|---|---|---|---|---|---|---|---|---|---|
| | | Capillary Diameter = | | | Capillary Diameter = | | | | |
| | | 0.009” (228 μm) | | | 0.0020” (508 μm) | | | | |
| | | | | Die 1 to | | | Die 2 to | Fiber | |
| | | | | collector | | | collector | Ratio | Basis |
| Example | Converging | Throughput | Air | distance | Throughput | Air | distance | Die 1: | weight |
| No. | Degree | (ghm) | (psi) | (cm) | (ghm) | (psi) | (cm) | Die 2 | (gsm) |
| 8 | High | 0.035 | 8 | 38 | 0.102 | 8 | 30 | 41:59 | 45 |
| 9 | High | 0.035 | 11 | 38 | 0.102 | 8 | 30 | 41:59 | 44 |
| 10 | High | 0.035 | 11 | 38 | 0.102 | 11 | 30 | 41:59 | 45 |
| 11 | High | 0.035 | 8 | 38 | 0.138 | 8 | 30 | 34:66 | 44 |
| 12 | High | 0.035 | 8 | 38 | 0.138 | 8 | 30 | 34:66 | 88 |
| 13 | Medium | 0.035 | 8 | 30 | 0.102 | 8 | 30 | 41:59 | 43 |
| 14 | Medium | 0.035 | 11 | 30 | 0.102 | 8 | 30 | 41:59 | 42 |
| 15 | Medium | 0.035 | 11 | 30 | 0.102 | 11 | 30 | 41:59 | 44 |
| 16 | Medium | 0.035 | 8 | 30 | 0.138 | 8 | 30 | 34:66 | 43 |
| 17 | Medium | 0.035 | 8 | 30 | 0.138 | 8 | 30 | 34:66 | 72 |
| 18 | Low | 0.035 | 8 | 23 | 0.102 | 8 | 30 | 41:59 | 50 |
| 19 | Low | 0.035 | 8 | 23 | 0.138 | 8 | 30 | 34:66 | 47 |
| 20 | Low | 0.035 | 11 | 23 | 0.138 | 8 | 30 | 34:66 | 40 |
| 21 | Low | 0.035 | 11 | 23 | 0.138 | 11 | 30 | 34:66 | 42 |
| 22 | Low | 0.035 | 11 | 23 | 0.138 | 11 | 30 | 34:66 | 97 |

Filtration performance was also evaluated with a TSI 3160 filter tester at face velocity of 5.3 cm/sec. 0.3 micron particles were used to measure filtration efficiency. Filtration efficiency (E), pressure drop (Δp) and quality factor (Q.F.) were recorded. Properties of the fabrics produced in examples 8-22 are provided in Table 2 below.

TABLE 2
Fabric Properties of Examples 8-22

| | | | Filtration Testing Results | | |
|---|---|---|---|---|---|
| | | | Pressure | | Quality |
| Example | Thickness | Solidity | Drop | Efficiency | Factor |
| ID | (μm) | (%) | (Pa) | (%) | (Pa⁻¹) |
| 8 | 521 | 9.5 | 35.1 | 41.2 | 0.015 |
| 9 | 731 | 6.9 | 34.5 | 44.3 | 0.017 |
| 10 | 507 | 9.3 | 36.2 | 43.0 | 0.016 |
| 11 | 349 | 13.7 | 24.9 | 28.5 | 0.013 |
| 12 | 711 | 13.7 | 47.2 | 47.8 | 0.014 |
| 13 | 390 | 12.1 | 22.0 | 28.1 | 0.015 |
| 14 | 352 | 13.1 | 24.6 | 30.5 | 0.015 |
| 15 | 367 | 13.4 | 26.0 | 30.2 | 0.014 |
| 16 | 688 | 7.1 | 11.5 | 20.8 | 0.020 |
| 17 | 481 | 15.7 | 33.7 | 33.2 | 0.012 |
| 18 | 516 | 10.8 | 29.7 | 35.0 | 0.014 |
| 19 | 855 | 6.0 | 14.9 | 24.1 | 0.019 |
| 20 | 660 | 6.3 | 16.5 | 26.9 | 0.019 |
| 21 | 626 | 7.4 | 15.3 | 22.8 | 0.017 |
| 22 | 596 | 18.0 | 44.1 | 41.0 | 0.012 |

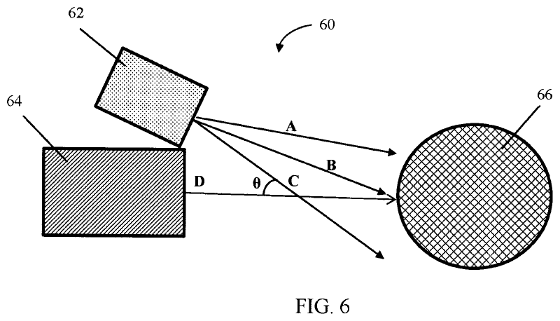

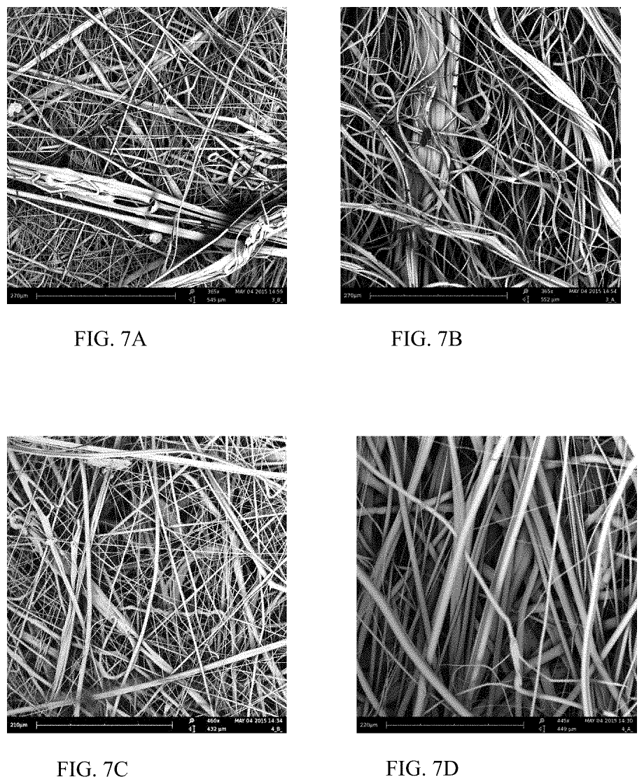

SEM images of examples with a high degree of converging are illustrated in FIGS. 7A-7D, for example. Each fabric sample has two sides, a small capillary side and a large capillary side. FIG. 7A illustrates the small capillary side of fabric example number 10 produced according to the parameters listed above. FIG. 7B illustrates the large capillary side of fabric example number 10 produced according to the parameters listed above. FIG. 7C illustrates the small capillary side of fabric example number 11 produced according to the parameters listed above. FIG. 7D illustrates the large capillary side of fabric example number 11 produced according to the parameters listed above. As illustrated in the SEM images, the two sides of a meltblown sample with a high degree of convergence are similar in appearance and difficult to distinguish.

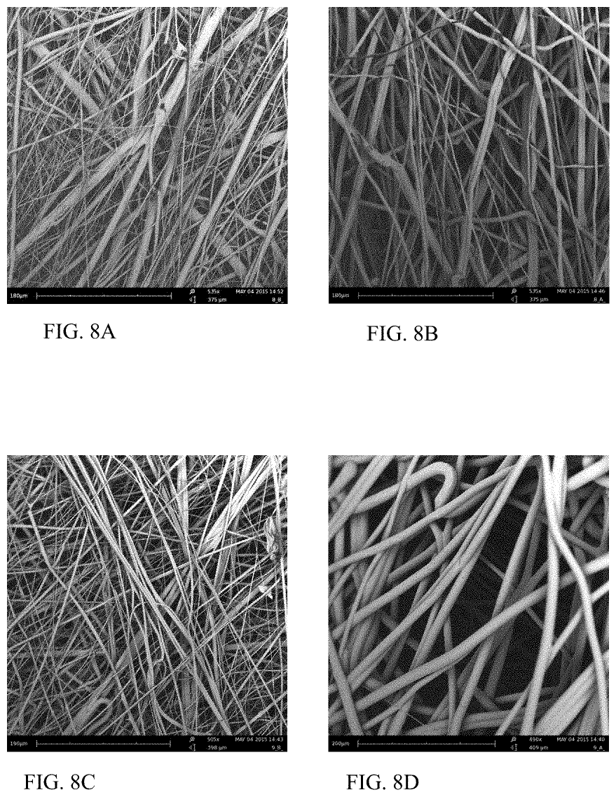

SEM images of examples with a medium degree of converging are illustrated in FIGS. 8A-8D, for example. As stated above, each fabric sample has two sides, a small capillary side and a large capillary side. FIG. 8A illustrates the small capillary side of fabric Example 15 produced according to the parameters listed above. FIG. 8B illustrates the large capillary side of fabric Example 15 produced according to the parameters listed above. FIG. 8C illustrates the small capillary side of fabric Example 16 produced according to the parameters listed above. FIG. 8D illustrates the large capillary side of fabric Example 16 produced according to the parameters listed above. As illustrated in the SEM images, the two sides of a meltblown sample with a medium degree of convergence are similar in appearance, but the two sides are more distinguishable than the two sides of a high convergence sample.

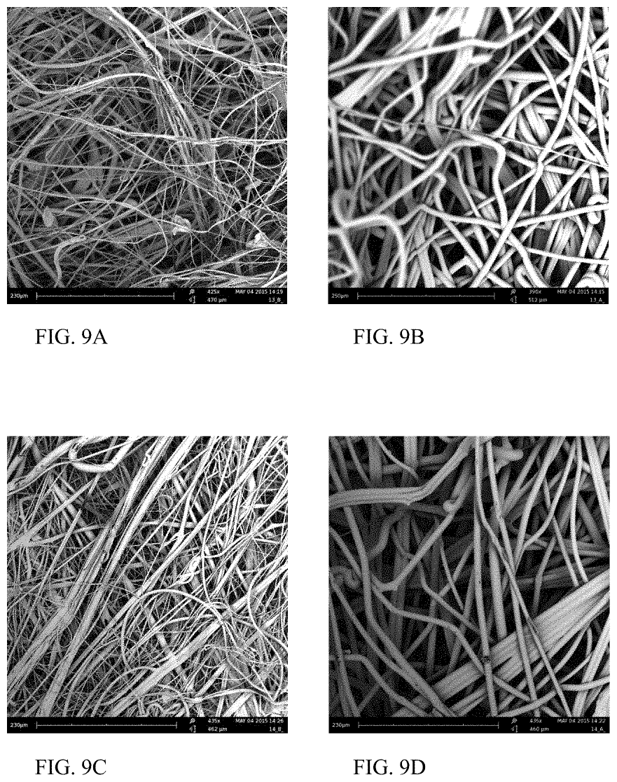

SEM images of examples with a low degree of converging are illustrated in FIGS. 9A-9D, for example. Each fabric sample has two sides, a small capillary side and a large capillary side. FIG. 9A illustrates the small capillary side of fabric Example 20 produced according to the parameters listed above. FIG. 9B illustrates the large capillary side of fabric Example 20 produced according to the parameters listed above. FIG. 9C illustrates the small capillary side of fabric Example 21 produced according to the parameters listed above. FIG. 9D illustrates the large capillary side of fabric Example 21 produced according to the parameters listed above. As illustrated in the SEM images, the two sides of a meltblown sample with a low degree of convergence are fairly distinct in appearance. The two sides are more distinguishable than the two sides of a high or a medium convergence sample.

### Examples 23-28

Examples of co-mingled meltblown structures were produced with a multi-die melt blowing system having two concentric air-type die types, as illustrated in FIG. 6 and described above.

Examples 23-28 comprise polypropylene resin METOCENE® MF650 W with melt flow rate of 500 supplied by Lyondellbaseell. The same polymer was used for both dies. A low throughput of 0.023 ghm was used in a first die to comingle fine fibers into coarse fibers provided by a second die having a throughput of 0.102 ghm. The degree of convergence was varied, as described in more detail above. Detailed production conditions of Examples 23-28 are provided in Table 3 below.

TABLE3
Production Conditions of Examples 23-28

| | | Die 1: | | | Die 2: | | | | |
|---|---|---|---|---|---|---|---|---|---|
| | | Capillary Diameter = | | | Capillary Diameter = | | | | |
| | | 0.009” (228 μm) | | | 0.0020” (508 μm) | | | | |
| | | | | Die 1 to | | | Die 2 to | Fiber | |
| | | | | collector | | | collector | Ratio | Basis |
| Example | Converging | Throughput | Air | distance | Throughput | Air | distance | Die 1: | weight |
| ID | Degree | (ghm) | (psi) | (cm) | (ghm) | (psi) | (cm) | Die 2 | (gsm) |
| 23 | High | 0.023 | 8 | 38 | 0.102 | 8 | 30 | 31:69 | 44 |
| 24 | High | 0.023 | 11 | 38 | 0.102 | 8 | 30 | 31:69 | 44 |
| 25 | High | 0.023 | 14 | 38 | 0.102 | 8 | 30 | 31:69 | 45 |
| 26 | Low | 0.023 | 8 | 26 | 0.102 | 8 | 30 | 31:69 | 47 |
| 27 | Low | 0.023 | 11 | 26 | 0.102 | 8 | 30 | 31:69 | 50 |
| 28 | Low | 0.023 | 14 | 26 | 0.102 | 8 | 30 | 31:69 | 48 |

Filtration performance was evaluated with TSI 3160 filter tester at face velocity of 5.3 cm/sec. 0.3 micron particles were used to measure filtration efficiency. Properties of the fabrics produced in examples 23-28 are provided in Table 4 below.

TABLE 4
Fabric Properties of Examples 23-28

| | | | Filtration Testing Results | | |
|---|---|---|---|---|---|
| | | | Pressure | | Quality |
| Example | Thickness | Solidity | Drop | Efficiency | Factor |
| ID | (μm) | (%) | (Pa) | (%) | (Pa⁻¹) |
| 23 | 430 | 11.4 | 33.3 | 35.8 | 0.0133 |
| 24 | 600 | 8.3 | 27.0 | 33.2 | 0.0150 |
| 25 | 897 | 5.7 | 19.3 | 28.7 | 0.0175 |
| 26 | 616 | 8.2 | 24.7 | 31.7 | 0.0154 |
| 27 | 501 | 11.1 | 26.0 | 30.8 | 0.0142 |
| 28 | 709 | 7.9 | 24.8 | 28.8 | 0.0137 |

SEM images of examples with a high degree of converging are illustrated in FIGS. 10A-10B, for example. Each fabric sample has two sides, a small capillary side and a large capillary side. FIG. 10A illustrates the small capillary side of fabric Example 25 produced according to the parameters listed above. FIG. 10B illustrates the large capillary side of fabric Example 25 produced according to the parameters listed above.

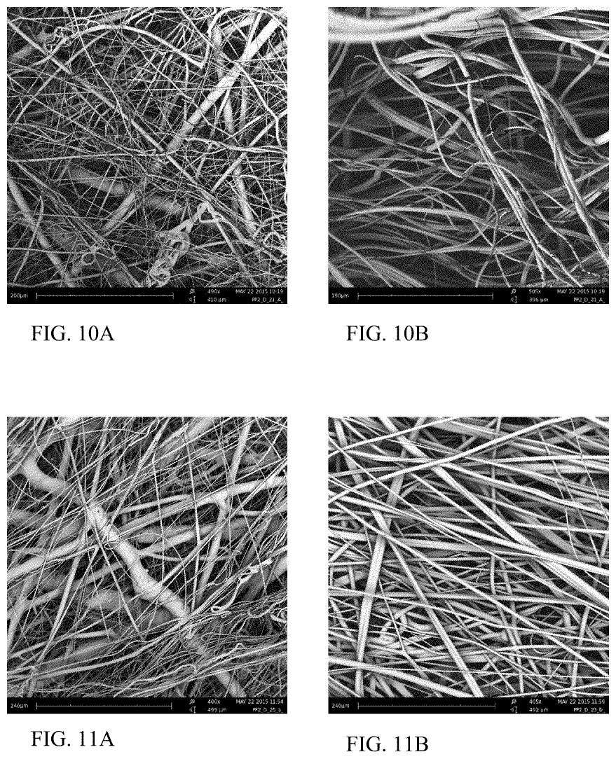

SEM images of examples with a low degree of converging are illustrated in FIGS. 11A-11B, for example. Each fabric sample has two sides, a small capillary side and a large capillary side. FIG. 11A illustrates the small capillary side of fabric Example 28 produced according to the parameters listed above. FIG. 11B illustrates the large capillary side of fabric Example 28 produced according to the parameters listed above. Similar to examples 8-22 above, the two sides of a meltblown sample with a low degree of convergence are fairly distinct in appearance. The two sides are more distinguishable than the two sides of a high convergence sample.

### Comparative Examples 29-31

Comparative Examples 29-31 are produced with a single die REICOFIL® melt blowing apparatus (single-row-impinging-air design). The die had capillaries with a diameter of 400 microns. Basis weight of these samples was about 40 gsm, similar to some of Examples 8-28. Examples 29 and 30 comprise polypropylene with a 500 melt flow rate. Specifically, METOCENE® MF650 W supplied by Lyondellbaseell was used for Examples 29 and 30. Example 31 comprises polypropylene with a 1200 melt flow rate. Specifically, METOCENE® MF650 X supplied by Lyondellbaseell was used for Example 31. Detailed production conditions of Examples 29-31 are provided in Table 5 below.

Basis weight and thickness of the webs were measured and filtration performance were evaluated with TSI 3160 filter tester at face velocity of 5.3 cm/sec. 0.3 micron particles were used to measure filtration efficiency. Properties of the fabrics produced in Examples 29-31 are also provided in Table 5 below.

TABLE 5
Production Conditions and Fabric Properties of Examples 29-31

| | | Sample Production | | | | | | | | |
|---|---|---|---|---|---|---|---|---|---|---|
| | | Process Condition | | | | | | Filtration Testing Results | | |
| | | Through- | | Air | Basis | Thick- | | | Filtration | Quality |
| Sample | | put | DCD | flow | weight | ness | Solidity | Pressure | Efficiency | Factor |
| ID | Polymer | (ghm) | (cm) | (m³/hr) | (gsm) | (μm) | (%) | drop (Pa) | (%) | (Pa⁻¹) |
| 29 | PP- | 0.6 | 30.0 | 1100 | 37 | 343 | 12.0 | 19.5 | 21.3 | 0.0006 |
| | 500MFR | | | | | | | | | |
| 30 | PP- | 0.9 | 22.5 | 1100 | 38 | 340 | 12.1 | 20.8 | 20.6 | 0.0007 |
| | 500MFR | | | | | | | | | |
| 31 | PP- | 0.6 | 30.0 | 1100 | 40 | 337 | 13.0 | 50.0 | 45.7 | 0.0021 |
| | 1200MFR | | | | | | | | | |

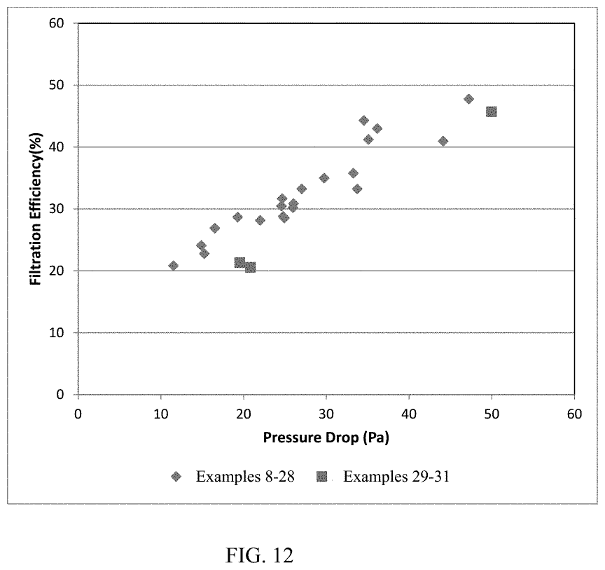

FIG. 12 is a graph comparing filtration performance of examples produced with a dual die apparatus (Examples 8-28) and Comparative Examples 29-31 produced with a single die system (i.e., no co-mingling of multiple fiber streams). As illustrated therein, examples produced with a dual die system showed higher filtration efficiency at the same approximate pressure drop. Additionally, the Quality Factor for Examples 8-28 are much higher than the Quality Factor of Comparative Examples 29-31. This indicates improved filtration performance for meltblown structures according to the invention with co-mingled fine and coarse fibers.

### Examples 32-42

Examples of co-mingled meltblown structures were produced with a multi-die melt blowing system having two concentric air-type die types, as illustrated in FIG. 6 and described above. Examples 32-42 comprise polypropylene resin METOCENE® MF650 W with melt flow rate of 500 supplied by Lyondellbaseell and polybutylene terephthalate (PBT) CRASTIN® FGS600F40NC010, MFR 33 g/10 min supplied from DuPont. A coarse fiber stream is issued from Die 2 (e.g., die 64 in system 60 of FIG. 6) comprising the PBT. A fine fiber stream is issued from Die 1 (e.g., die 62 in system 60 of FIG. 6) comprising the polypropylene. Detailed production conditions of Examples 32-42 are provided in Table 6 below.

TABLE 6
Production Conditions of Examples 32-42

| | | Die 1: | | | Die 2: | | | | |
|---|---|---|---|---|---|---|---|---|---|
| | | Capillary Diameter = | | | Capillary Diameter = | | | | |
| | | 0.009” (228 μm) | | | 0.0020” (508 μm) | | | | |
| | | | | Die 1 to | | | Die 2 to | Fiber | |
| | | | | collector | | | collector | Ratio | Basis |
| Example | Converging | Throughput | Air | distance | Throughput | Air | distance | Die 1: | weight |
| ID | Degree | (ghm) | (psi) | (cm) | (ghm) | (psi) | (cm) | Die 2 | (gsm) |
| 32 | High | 0.038 | 8 | 38 | 0.334 | 8 | 30 | 18:82 | 43 |
| 33 | High | 0.038 | 8 | 38 | 0.334 | 8 | 30 | 18:82 | 91 |
| 34 | High | 0.038 | 8 | 38 | 0.334 | 8 | 30 | 18:82 | 139 |
| 35 | High | 0.038 | 11 | 38 | 0.334 | 8 | 30 | 18:82 | 43 |
| 36 | High | 0.038 | 11 | 38 | 0.334 | 8 | 30 | 18:82 | 87 |
| 37 | High | 0.038 | 11 | 38 | 0.334 | 8 | 30 | 18:82 | 134 |
| 38 | Low | 0.038 | 8 | 26 | 0.334 | 8 | 30 | 18:82 | 44 |
| 39 | Low | 0.038 | 8 | 26 | 0.334 | 8 | 30 | 18:82 | 89 |
| 40 | Low | 0.038 | 8 | 26 | 0.334 | 8 | 30 | 18:82 | 138 |
| 41 | Low | 0.038 | 11 | 26 | 0.334 | 8 | 30 | 18:82 | 45 |
| 42 | Low | 0.038 | 11 | 26 | 0.334 | 8 | 30 | 18:82 | 88 |

Basis weight and thickness of the webs were measured and filtration performance were evaluated with TSI 3160 filter tester at face velocity of 5.3 cm/sec. 0.3 micron particles were used to measure filtration efficiency. Properties of the fabrics produced in Examples 32-42 are provided in Table 7 below.

TABLE 7
Fabric Properties of Examples 32-42

| | | | Filtration Testing Results | | |
|---|---|---|---|---|---|
| | | | Pressure | | Quality |
| Example | Thickness | Solidity | Drop | Efficiency | Factor |
| ID | (μm) | (%) | (Pa) | (%) | (Pa⁻¹) |
| 32 | 432 | 8.3 | 9.7 | 25.9 | 0.0308 |
| 33 | 550 | 13.8 | 22.2 | 33.8 | 0.0186 |
| 34 | 773 | 15.1 | 33.6 | 43.6 | 0.0170 |
| 35 | 361 | 10.1 | 10.7 | 23.5 | 0.0251 |
| 36 | 577 | 12.6 | 24.2 | 37.8 | 0.0196 |
| 37 | 863 | 13.0 | 30.9 | 45.2 | 0.0194 |
| 38 | 775 | 4.7 | 8.4 | 31.2 | 0.0445 |
| 39 | 902 | 8.3 | 17.6 | 40.8 | 0.0297 |
| 40 | 1027 | 11.3 | 32.0 | 51.2 | 0.0224 |
| 41 | 782 | 4.8 | 8.2 | 33.4 | 0.0495 |
| 42 | 884 | 8.3 | 18.4 | 47.0 | 0.0346 |

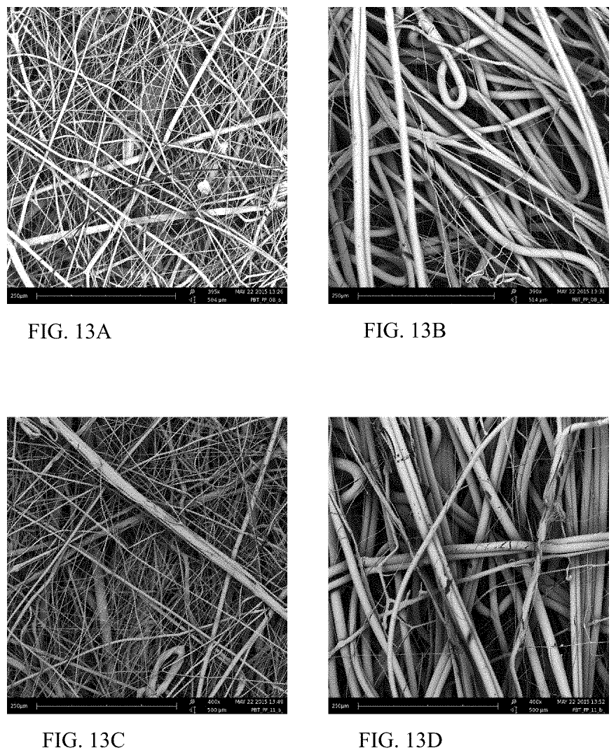

SEM images of examples with a high degree of converging are illustrated in FIGS. 13A-13D, for example. Each fabric sample has two sides, a small capillary side and a large capillary side. FIG. 13A illustrates the small capillary side of fabric Example 32 produced according to the parameters listed above. FIG. 13B illustrates the large capillary side of fabric Example 32 produced according to the parameters listed above. FIG. 13C illustrates the small capillary side of fabric Example 35 produced according to the parameters listed above. FIG. 13D illustrates the large capillary side of fabric Example 35 produced according to the parameters listed above.

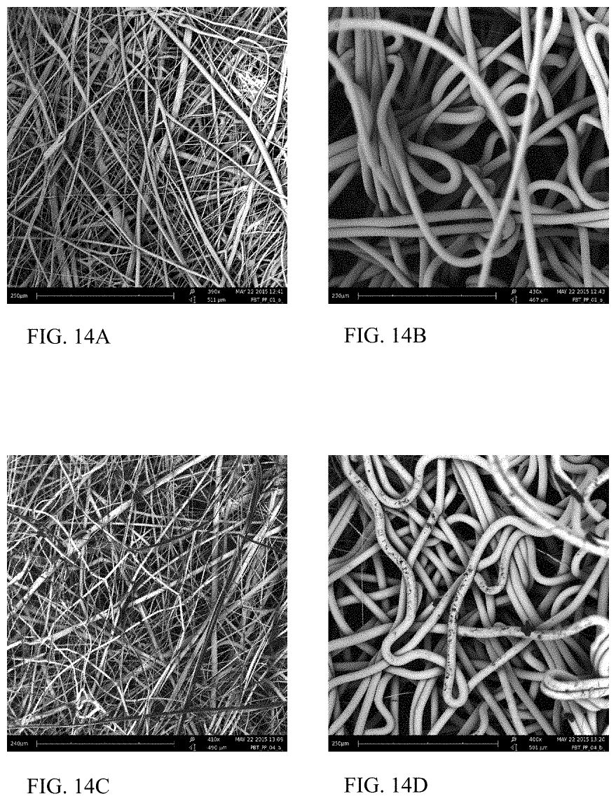

SEM images of examples with a low degree of converging are illustrated in FIGS. 14A-14D, for example. Each fabric sample has two sides, a small capillary side and a large capillary side. FIG. 14A illustrates the small capillary side of fabric Example 38 produced according to the parameters listed above. FIG. 14B illustrates the large capillary side of fabric Example 38 produced according to the parameters listed above. FIG. 14C illustrates the small capillary side of fabric Example 41 produced according to the parameters listed above. FIG. 14D illustrates the large capillary side of fabric Example 41 produced according to the parameters listed above. Similar to previous examples described above, the two sides of a meltblown sample with a low degree of convergence are fairly distinct in appearance. The two sides are more distinguishable than the two sides of a high convergence sample.

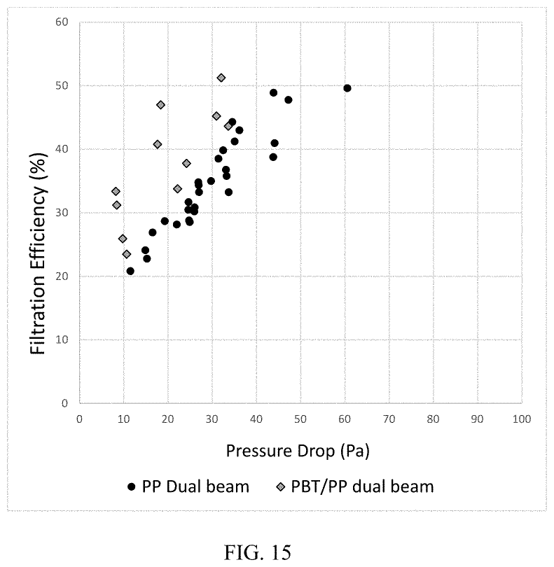

FIG. 15 is a graph comparing filtration performance of polypropylene samples produced with a dual die apparatus to filtration performance of PP/PBT samples produced with a dual die apparatus in Examples 32-42 and the PP co-mingled samples of Examples 8-28. It is apparent that the co-mingled PP/PBT fabrics exhibited higher filtration efficiency at comparable pressure drops as compared to the PP-only fabrics.

For certain commercially available filter media, when discharged with IPA immersion according to EN 779 standard before testing to remove electrostatic charge introduced during filter manufacturing, filtration efficiency is about 2-15% at about 10-25 Pa pressure drop, and the filtration efficiency is about 5-25% at about 25-40 Pa pressure drop, and the filtration efficiency is about 20-30% at about 40-60 Pa pressure drop. Accordingly, it is apparent from FIG. 15 that the co-mingled samples produced with a dual die apparatus according to the present invention showed enhanced filtration results over certain commercially available filter media.

Example fabrics 33 and 39 were pleated with a digital CNC controlled blade pleating machine made by JCEM GmbH. As illustrated in FIGS. 16A and 16B, for example, these fabrics were successfully pleated and self-supporting.

### Comparative Examples 43-44

Comparative Examples 43 and 44 are produced using only the second die 64 (concentric air design) of the multi-die system illustrated in FIG. 6. Examples 43 and 44 comprise polypropylene with 500 melt flow rate. Specifically, Metocence MF650 W supplied by Lyondellbaseell was used for Examples 43 and 44. Detailed production conditions of Examples 43 and 44 are provided in

Table 8 below.

TABLE 8
Production Conditions of Examples 43 and 44

| | | Die 1: | | | Die 2: | | | |
|---|---|---|---|---|---|---|---|---|
| | | Capillary Diameter = | | | Capillary Diameter = | | | |
| | | 0.009” (228 μm) | | | 0.0020” (508 μm) | | | |
| | | | | Die 1 to | | | Die 2 to | |
| | | | | collector | | | collector | Basis |
| Example | Converging | Throughput | Air | distance | Throughput | Air | distance | weight |
| ID | Degree | (ghm) | (psi) | (cm) | (ghm) | (psi) | (cm) | (gsm) |
| 43 | N.A. | 0 (not used) | 0 | — | 0.102 | 11 | 30 | 42 |
| 44 | N.A. | 0 (not used) | 0 | — | 0.138 | 11 | 30 | 45 |

Basis weight and thickness of the webs were measured and filtration performance were evaluated with a TSI 3160 filter tester at face velocity of 5.3 cm/sec. 0.3 micron particles were used to measure filtration efficiency. Properties of the fabrics produced in Examples 43 and 44 are provided in Table 9 below.

TABLE 9
Fabric Properties of Examples 43 and 44

| | | | Filtration Testing Results | | |
|---|---|---|---|---|---|
| | | | Pressure | | Quality |
| Example | Thickness | Solidity | Drop | Efficiency | Factor |
| ID | (μm) | (%) | (Pa) | (%) | (Pa⁻¹) |
| 43 | 331 | 14.1 | 16.6 | 18.7 | 0.0125 |
| 44 | 474 | 10.3 | 8.9 | 11.3 | 0.0135 |

Comparing the filtration testing results for these comparative examples to the data of FIG. 15, it is apparent that the single die comparative examples (i.e., no co-mingling of multiple fiber streams) do not provide the same filtration performance. For example, all of the co-mingled samples from the present examples exhibited a filtration efficiency of greater than 20% at a pressure drop of between 10 and 20 Pa.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of forming a nonwoven fabric of co-mingled meltblown fibers, the method comprising:
drawing a first plurality of fibers from a first polymer having a melt flow index of 500 or lower, using a first die comprising a plurality of spinneret nozzles facing a collector surface having a surface positioned to receive a plurality of fibers, wherein the first die has a concentric air design comprising nozzles with a capillary diameter in the range of 500 microns to 850 microns and with individual concentric air jets surrounding each nozzle; and
drawing a second plurality of fibers from a second polymer having a melt flow index of 500 or higher, using a second die comprising a plurality of spinneret nozzles having a capillary diameter in the range of 100 microns to 500 microns and facing the collector surface, and wherein the first and the second plurality of fibers are drawn in such a way and the second die is positioned in such a way, that the second plurality of fibers have fiber diameters of less than 10 microns and the first plurality of fibers and the second plurality of fibers form a co-mingled nonwoven web on the collector surface,
wherein the co-mingled nonwoven web formed of fibers has varying fiber diameters and the first plurality of fibers has a larger average diameter than the second plurality of fibers.

2. The method of claim 1, wherein the second die has a concentric air design with individual concentric air jets surrounding each of the plurality of spinneret nozzles or which is a single-row-capillary type die design with impinging air streams from both sides of a die tip.

3. The method of claim 1, wherein the first polymer is of the same polymer species as the second polymer, and wherein the melt flow viscosity of the first polymer is different from the melt flow viscosity of the second polymer.

4. The method of claim 1, wherein the first polymer is from a different polymer species than the second polymer.

5. The method of claim 1, wherein the second polymer comprises a first polyolefin polymer and the first polymer comprises at least one of a polyamide, a polyester, elastomers, a second polyolefin, and combinations thereof.

6. The method of claim 1, wherein the second polymer comprises polypropylene and the first polymer comprises polybutylene terephthalate.

7. The method of claim 1, further comprising introducing a third material into the co-mingled web on the collector surface using an applicator, wherein the third material is selected from the group consisting of a particulate material, a fibrous material, a plurality of capsules, and combinations thereof.

8. The method of claim 1, further comprising introducing a third material into the co-mingled web on the collector using an applicator, wherein the third material is a carded web or a textile fabric comprising a plurality of fibers, a film-like material, or paper.

9. The method of claim 1, further comprising producing the co-mingled nonwoven web such that it is pleatable or moldable.

10. The method of claim 1, further comprising introducing a third material into the co-mingled web on the collector surface using an applicator.

11. A nonwoven fabric comprising co-mingled meltblown fibers of different diameters comprising a first plurality of fibers formed of a polymer and a second plurality of fibers formed of a polymer having a melt flow index of 500 or higher, the second plurality of fibers having fiber diameters of less than 10 microns and wherein the first plurality of fibers have a larger average diameter than the second plurality of fibers.

12. The nonwoven fabric of claim 11, wherein the second polymer comprises a first polyolefin polymer and the first polymer comprises at least one of a polyamide, a polyester, elastomers, a second polyolefin, and combinations thereof.

13. The nonwoven fabric of claim 11, wherein the second polymer comprises polypropylene and the first polymer comprises polybutylene terephthalate.

14. The nonwoven fabric of claim 11, wherein the nonwoven fabric is in the form of pleated or molded filtration media.
